(19) United States
(12) Patent Application Publication
(10) Pub. No.: US 2009/0313263 A1
(43) Pub. Date: Dec. 17, 2009

(54) Multi-Media Server

(75) Inventor: Yuzo SATO, Tokyo (JP)

Correspondence Address: YOUNG LAW FIRM, P.C.;ALAN W. YOUNG, 4370 ALPINE ROAD, SUITE 106, PORTOLA VALLEY, CA, 94028, US

(73) Assignee: TDK Corporation, Tokyo (JP)

(21) Appl. No.: 12/483,921

(22) Filed: Jun. 12, 2009

(30) Foreign Application Priority Data
Jun. 16, 2008 (JP) 2008-157158
Jun. 16, 2008 (JP) 2008-157159

(51) Int. Cl. G06F 17/30; G06F 7/00; G06F 3/048

(52) U.S. Cl. 707/10; 707/104.1; 715/810; 707/E17.01; 707/E17.032

(57) ABSTRACT

A multi-media server capable of connecting to a digital television is provided with a file importing unit for importing a multi-media file from an external device, a storage unit for storing therein the imported multi-media file, a file reproducing unit for reproducing the multi-media file stored in the storage unit, a database for managing the multi-media file stored in the storage unit for each folder, and a folder setting unit for acquiring creation-date data of the imported multi-media file, displaying a list of fixed folder names associated at least with a month of the creation date, and setting one fixed folder name selected from the list as a destination folder name of the imported multi-media file.

### TECHNICAL FIELD

The present invention relates to a multi-media server, more particularly relates to a compact and highly operable multi-media server specialized for reproduction and management of moving images, still images, and music.

### BACKGROUND OF THE INVENTION

Recently, due to the wide spread use of digital contents, the time has come when an individual person holds and manages a large quantity of digital contents. Generally, the digital contents are managed in a personal computer. Although the personal computer provides quite high versatility, it cannot manage the digital contents straightforwardly.

As described in Japanese Patent Application Laid-open No. H10-134485, for example, as a method of managing digital contents using a personal computer, there is proposed a storage-sharing distribution multi-media server system in which by sharing a storage, a service can be provided with the minimum amount of copying even when accesses are concentrated on the same content. Japanese Patent Application Laid-open No. H10-133828 describes that there is developed a disk array device for a multi-media server, including a plurality of disk drives, in which data are distributed and accommodated in (a storage medium attached to) each disk drive to enable a parallel access, thereby accelerating the access.

Conventionally, a multi-media file such as a moving image and a still image is provided with data including a date (year, month, and day) and a time, as data indicating when the file is created. For example, in a file of a still image taken by a digital camera or the like, data such as “2008/02/11 11:37” is provided as the date and time when the still image is taken. In many cases, a file name includes such data of date and time. However, there is a problem in that even when the file is imported to the multi-media server as it is, the date and time is the only key, and thus, even if the user wants to see the file and intends to search for the file later, the search requires much time and labor. Therefore, the user cannot easily reach contents that he or she desires. This problem becomes more significant when the number of files accumulated becomes so large.

Further, in an external device such as a video camera and a digital still camera, multi-media such as a moving image and a still image are saved within predetermined folders, and the folders are hierarchized. When data in the external device is processed on a personal computer, the folders are displayed in the order of directory hierarchy. However, a multi-media server used in general households has a problem in that when the directory hierarchy is displayed, confusion in processing is caused, and it takes time until the user reaches a file that he or she desires. Particularly, it is impossible for a person with insufficient knowledge about a personal computer to determine which folder in the directory hierarchy contains the file that is desired to see, and it is quite inconvenient to use it.

### SUMMARY OF THE INVENTION

The present invention has been achieved to solve the above problems, and an object of the present invention is to provide a multi-media server capable of easily finding a sought multi-media file and convenient for the user to use, and particularly, to provide a multi-media server capable of efficiently categorizing multi-media files.

In order to solve the above-described problems, a multi-media server of the present invention is configured to connect to a digital television and comprises a file importing unit that imports a multi-media file from an external device, a storage unit that stores therein the imported multi-media file, a file reproducing unit that reproduces the multi-media file stored in the storage unit, a database that manages the multi-media file stored in the storage unit for each folder, and a folder setting unit that acquires creation-date data of the imported multi-media file, displays a list of fixed folder names associated at least with a month of the creation date, and sets one fixed folder name selected from the list as a destination folder name of the imported multi-media file.

In this case, the multi-media file may be a moving image file, a still image file, a music file, or a composite file thereof. File formats thereof are not particularly limited. For a moving image, an mpg file, an avi file, or the like can be used. For a still image, a bmp file, a jpg file, a gif file, or the like can be used. For a music file, a wav file, an mp3 file, an aac file, an ogg file, or a mid file can be used.

According to the present invention, it is possible to select the most suitable folder name from among several candidates of fixed folder names that appear appropriate as viewed from a period during which a multi-media file is created, and it is also possible to easily set a folder name of an import file. Accordingly, it becomes easy to manage digital contents, and thus it is possible to easily find a multi-media file that is desired to be reproduced.

It is preferred that the folder setting unit according to the present invention sets, in addition to the fixed folder name, an icon image associated with the fixed folder name as an icon image of the destination folder of the imported multi-media file. In this case, it is further preferred that the folder setting unit displays, in addition to the fixed folder name, a plurality of icon images associated with the fixed folder name, and sets one icon image selected from among the icon images as an icon image of the destination folder of the imported multi-media file. Accordingly, it is possible to set, together with the folder name, the most suitable icon image from among candidates of several icon images that appear appropriate as viewed from a creation date of a multi-media file. Accordingly, it becomes easier to manage digital contents, and thus a multi-media file that is desired to be reproduced can be easily found.

It is preferred that the multi-media server according to the present invention further comprises a reproduction-list display unit that displays a reproduction list including the folder name and the icon image of the folder registered in the database. The file reproducing unit may reproduce the multi-media file saved in the folder selected from the reproduction list displayed by the reproduction-list display unit. Accordingly, when the folder name and the icon image are used as a key, a file to be reproduced can be easily found.

It is preferred that the folder setting unit according to the present invention further displays a list of all registered fixed folder names, in addition to the list of the fixed folder names associated at least with the month of the creation date. Accordingly, even when there is no appropriate folder name in a monthly folder list, an appropriate folder name can be selected from an all folder list, and thus a highly convenient system can be provided.

It is preferred that the file importing unit according to the present invention includes an automatic importing unit that automatically imports multi-media files from the external device, and a manual importing unit that imports a multi-media file selected by a user from among the multi-media files, from the external device. In this case, “automatically import” means to start, in response to connection of an external device, searching for a predetermined multi-media file and importing the retrieved multi-media file. According thereto, options of an import method can be increased, and thus a more highly convenient system can be realized.

It is preferred that the multi-media server according to the present invention, further comprising a character input unit. The folder setting unit may set a character string directly inputted via the character input unit as the destination folder name of the multi-media file. Even when there is no appropriate folder name in the monthly folder list or the all folder list, a suitable name can be provided to a multi-media file that is to be imported by directly inputting a folder name from the character input unit. Accordingly, it becomes easier to manage the digital contents, and thus a multi-media file that is desired to be reproduced can be easily found.

It is preferred that the multi-media server according to the present invention, further comprises a directory-structure detecting unit that detects a specific directory structure within the external device and a file display unit that displays a list of multi-media files within a predetermined folder of the specific directory structure when the directory structure is detected, to enable a user to select an import-target multi-media file.

According to the present invention, when a unique directory structure of a digital video camera or a digital still camera that complies with a predetermined standard is detected, a predetermined folder holding multi-media files in the directory structure is directly accessed so as to display a list of multi-media files. Thus, a user does not need to search for a folder holding the multi-media files. Accordingly, it is possible to provide a highly convenient multi-media server that is straightforward to operate.

It is preferred that the directory-structure detecting unit detects the specific directory structure when connection of the external device is recognized. Accordingly, even when a particular instruction is not provided from a user, the directory structure can be automatically recognized and a predetermined folder in the directory structure can be opened.

It is preferred that the multi-media server of the present invention is configured to connect to a digital television and comprises a directory-structure detecting unit that detects a specific directory structure within an external device and a file display unit that displays a list of multi-media files within a predetermined folder of the specific directory structure when the directory structure is detected. The directory-structure detecting unit may detect the specific directory structure when connection of the external device is recognized. The multi-media server of the present invention, further comprises a file importing unit that imports at least one multi-media file selected on the file display unit, a storage unit that stores therein the imported multi-media file and a file reproducing unit that reproduces the multi-media file stored in the storage unit. Accordingly, it is possible to provide a multi-media server capable of importing, accumulating, and reproducing several multi-media files selected from a list of multi-media files within a predetermined folder of a specific directory structure.

As described above, in the present invention, when importing a multi-media file from an external device, a folder name and an icon image of a destination folder of the multi-media file is selected from a list of fixed folder names classified into months and set. Accordingly, it becomes easy to manage digital contents, thereby easing finding of a multi-media file to be reproduced. Further, according to the present invention, a list of multi-media files within a predetermined folder is directly displayed, rather than displaying directory structures in order in a specific external device. Therefore, it is possible to provide a multi-media server that is convenient for a user.

### BRIEF DESCRIPTION OF THE DRAWINGS

The above and other objects, features and advantages of this invention will become more apparent by reference to the following detailed description of the invention taken in conjunction with the accompanying drawings, wherein:

FIG. 1 is a schematic block diagram showing a configuration of a multi-media server system according to the first embodiment;

FIG. 2A is a perspective view on a front panel side of the multi-media server according to the first embodiment;

FIG. 2B is a perspective view on a back panel side of the multi-media server according to the first embodiment;

FIG. 3 is a schematic block diagram showing an internal configuration of the multi-media server according to the first embodiment;

FIG. 4 is a functional block diagram of the multi-media server according to the first embodiment;

FIG. 5 is a table showing the information of multi-media files managed by the database according to the first embodiment;

FIG. 6 is a table showing one example of a database for managing the fixed folder names and the icon images according to the first embodiment;

FIG. 7 is one example of the monthly folder list with the fixed folder name according to the first embodiment;

FIG. 8 is a flowchart for explaining the process of the multi-media server according to the first embodiment;

FIG. 9 is a schematic diagram showing one example of the folder setting screen according to the first embodiment;

FIG. 10 is a schematic diagram showing one example of a screen layout of a reproduction list according to the first embodiment;

FIG. 11 is a table showing the multi-media file information managed by the database according to the second embodiment;

FIG. 12A is one example of the directory structure of multi-media files in the external device which complies with AVCHD®, according to the second embodiment;

FIG. 12B is one example of the directory structure of multi-media files in the external device which complies with JEIDA, according to the second embodiment;

FIG. 13 is a flowchart for explaining the process of multi-media server according to the second embodiment; and

FIG. 14 is a schematic diagram showing one example of the file list screen according to the second embodiment.

### DETAILED DESCRIPTION OF THE EMBODIMENTS

Preferred embodiments of the present invention will be explained below in detail with reference to the accompanying drawings. First, a method of determining a destination folder when importing digital contents is described as a first embodiment of the present invention. A method of displaying a list of multi-media files in an external device is described next as a second embodiment of the present invention. Multi-media servers according to the first and second embodiments can be different devices, or the first and second embodiments can be understood as two different aspects of a single multi-media server. Whether the multi-media servers according to the first and second embodiments are a single device or different devices does not affect the essence of the present invention.

### First Embodiment

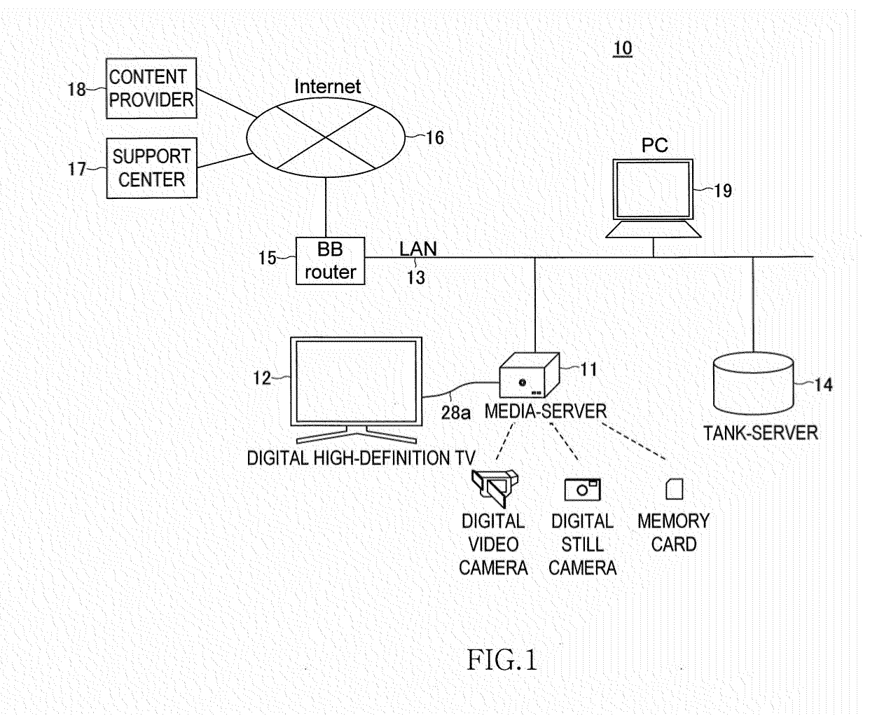

FIG. 1 is a schematic block diagram showing a configuration of a multi-media server system according to the first embodiment.

As shown in FIG. 1, a multi-media server system 10 according to the first embodiment includes a multi-media server 11 that reproduces and manages a multi-media file or the like, and a tank server 14 that is connected via a home LAN 13 to the multi-media server 11. The multi-media server 11 is configured to connect to a digital high-definition television 12. The function can be realized by a terminal for connecting an HDMI (High Definition Multimedia Interface) cable or a wireless LAN, for example. In the case of the wireless LAN, IEEE 802.11a/b/g or IEEE 802.11n can be used, and a WHDI (Wireless High-Definition Interface) capable of transmitting data in an uncompressed state can be also used. The home LAN 13 is connected to the Internet 16 via home gateway such as broad-band router 15. On the Internet 16, there are a support center 17 that provides firmware or an application program within the multi-media server 11, a content provider 18 that provides a digital content itself or tag information of the digital content, and the like. Generally, the home LAN 13 is connected with a personal computer 19, and it is also possible to access the multi-media server 11 or the tank server 14 through the personal computer 19. The home LAN can be realized by a cable connection, and can be also configured by a wireless LAN such as IEEE 802.11a/b/g and IEEE 802.11n.

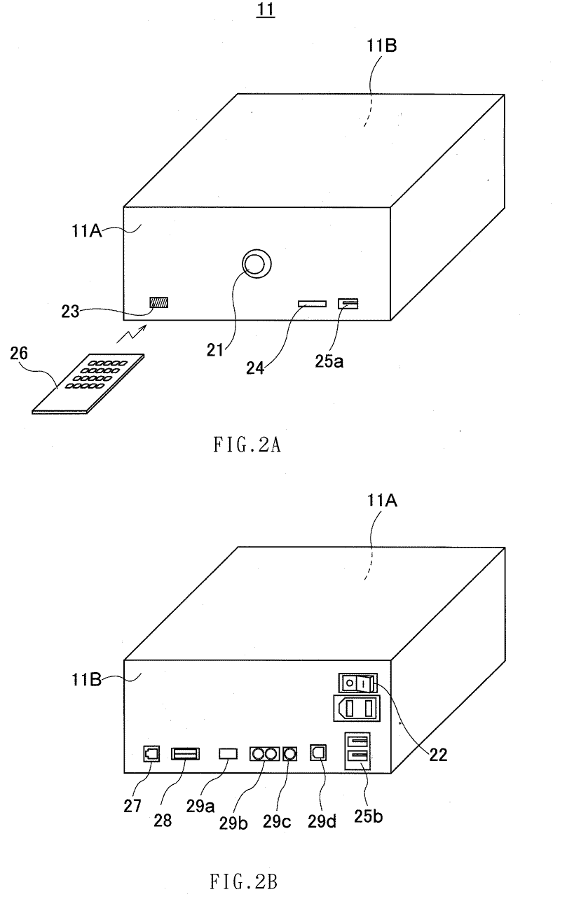

FIGS. 2A and 2B show an exterior structure of the multi-media server 11 according to the first embodiment. FIG. 2A is a perspective view thereof on a front panel side and FIG. 2B is a perspective view thereof on a back panel side.

As shown in FIGS. 2A and 2B, the multi-media server 11 has a compact and simple structure in a horizontal box shape. Accordingly, installation even in a narrow space around the large digital high-definition television 12 is enabled.

As shown in FIG. 2A, on a front panel of an enclosure of the multi-media server 11, a power switch button 21, an infrared receiving panel 23, a memory card slot 24, and a USB (Universal Serial Bus) terminal 25a are provided. The power switch button 21 configures an LED display unit, and a power input state or an operation state can be confirmed based on a flickering state of the LED. The infrared remote controller is attached to the multi-media server 11 and the infrared receiving panel 23 can receive command signal from the infrared remote controller 26. The memory card slot 24 is a dedicated slot for various memory cards such as an SD card (registered trademark). The USB terminal 25a is configured to connect via a USB cable with a USB device (external device) such as a digital camera and a digital video camera.

As shown in FIG. 2B, on a back panel of the enclosure of the multi-media server 11, there are provided a main power switch 22, an LAN port 27, and various terminals such as an HDMI terminal 28, a composite video terminal 29a, a stereo audio terminal 29b, an S-Video terminal 29c, an SPDIF terminal 29d, and a USB terminal 25b. The multi-media server 11 is configured to connect to LAN 13 via LAN port 27. Further, the multi-media server is configured to connect with the digital high-vision television (display) 12 via the HDMI cable 28a (shown in FIG. 1) and the HDMI terminal 28.

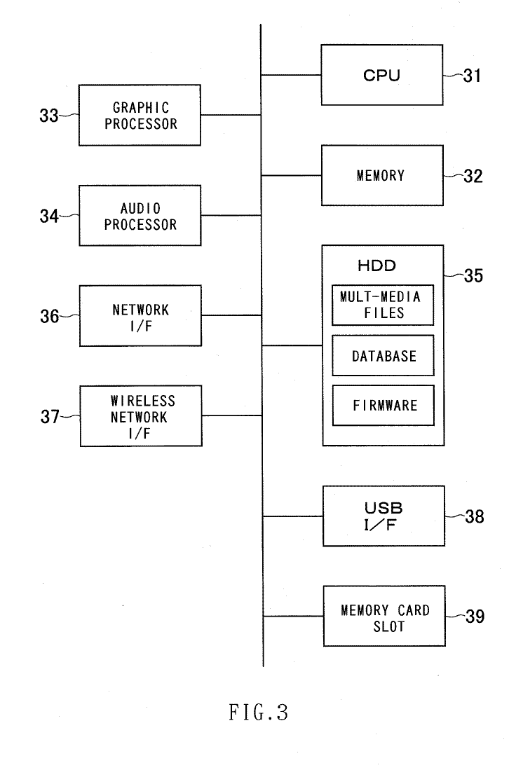

FIG. 3 is a schematic block diagram showing an internal configuration of the multi-media server 11 according to the first embodiment.

As shown in FIG. 3, multi-media server 11 includes a CPU 11, a memory 32, a graphic-processor 33, an audio-processor 34, a hard disk drive 35, a network interface 36, a wireless network interface 37, a USB interface 38, memory card slot 39. The multi-media server 11 uses a dedicated OS (operating system), and this lessens a load applied to the CPU 31. Thus, it is possible to use a CPU with lower specifications than those of a personal computer.

The hard disk drive 35 not only accommodates multi-media files but also stores therein a database for managing the multi-media files. Besides, firmware such as an OS, to control the multi-media server 11 is also stored in the hard disk drive 35. The firmware and the like are loaded at power-on. Preferably, the hard disk drive 35 has a capacity as large as possible, and has a recording capacity of about 300 to 500 GB, for example. The multi-media server 11 according to the first embodiment is equipped with not only the network interface 36 for the wired communication but also the wireless network interface 37 for the wireless communication. Therefore, this server can connect to both wired LAN and wireless LAN. Particularly, when a digital camera or a digital video camera is compatible with the wireless LAN, exchanging data via the wireless LAN is also possible.

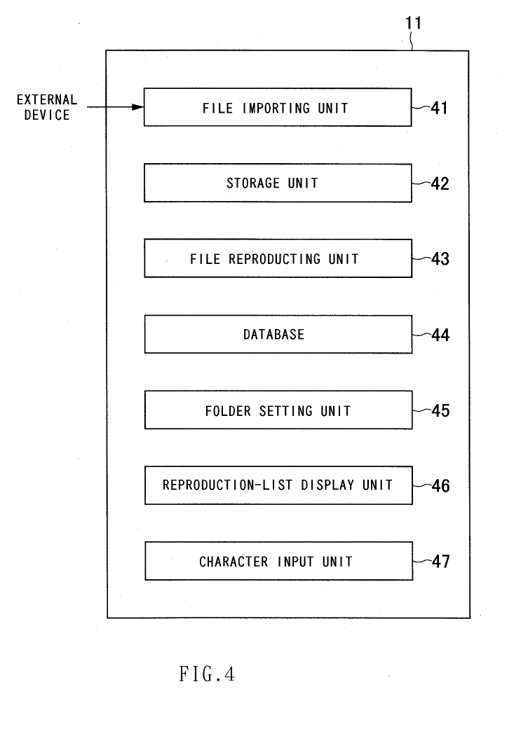

FIG. 4 is a functional block diagram of the multi-media server 11 according to the first embodiment.

As shown in FIG. 4, the multi-media server 11 includes a file importing unit 41 that imports multi-media files from an external device by collaborating with software and hardware shown in FIG. 3, a storage unit 42 that accommodates the imported multi-media files, a file reproducing unit 43 that reproduces the multi-media files stored in the storage unit 42, a database 44 that manages the multi-media files stored in the storage unit 42, a folder setting unit 45 that determines a destination folder and an icon image of the imported multi-media file, a reproduction-list display unit 46 that displays a reproduction list including the folder name and the icon image.

The file importing unit 41 has an automatic importing function of automatically importing the multi-media files from the external device, and a manual importing function of importing a multi-media file selected by a user from among the multi-media files within the external device. The file reproducing unit 43 is capable of sequentially reproducing the multi-media files within an arbitrary folder selected by the reproduction-list display unit 46.

The folder setting unit 45 is configured to acquire a creation date of the imported multi-media file and display a list of fixed folder names associated with the “month” of the creation date (hereinafter, “monthly folder list”), and display a list of all registered fixed folder names (hereinafter, “all folder list”). The user can select an appropriate folder name from among the plural fixed folder names. The user can select the fixed folder name with the infrared remote controller 26.

The folder setting unit 45 further includes a function of displaying icon images associated with the fixed folder names. The user can select a single icon image from among a plurality of icon images, and the folder setting unit 45 sets the selected icon image as an icon image of a destination folder of an import file.

The multi-media server 11 includes a character input unit 47 such as software keyboard. The folder setting unit 45 sets a character string directly inputted from the character input unit 47 as the destination folder name of the imported file. Thus, the user can set arbitrary string as the name of the destination folder.

The multi-media files processed by the multi-media server system 10 according to the first embodiment mainly include three types, i.e., a moving image file, a still image (photograph) file, and a music file. While even in normal states, the sizes of these files are large, these files have such properties that the higher the quality, the larger the size. The multi-media server 11 includes the database 44 for managing these multi-media files. Information of the multi-media files managed by the database 44 is extracted from contents when the contents are imported, or acquired by accessing the content provider 18 on the Internet 16, or acquired by a user's direct input.

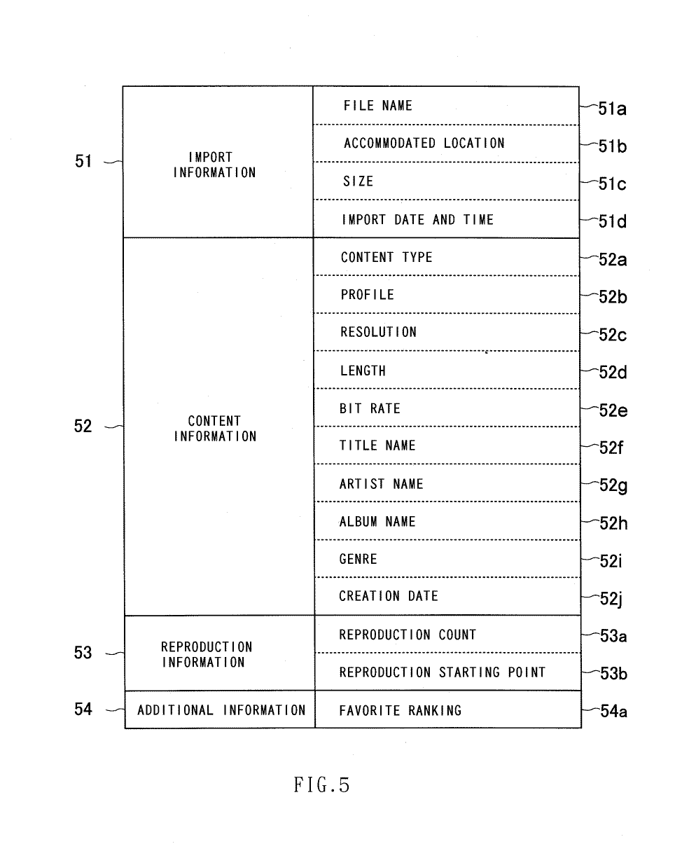

FIG. 5 is a table showing the information of multi-media files managed by the database 44 according to the first embodiment.

As shown in FIG. 5, the information of the multi-media files is classified into four types. These are “import information” 51, “content information” 52, “reproduction information” 53 and “additional information” 54. Among the information, the “import information” 51 is obtained when the multi-media file is imported. The import information 51 includes a “file name” 51a indicating an actual file name, an “accommodated location” 51b indicating an accommodated location of the multi-media file within the multi-media server 11 (or within the tank server 14), a “size” 51c indicating an actual file size, and an “import date and time” 51d indicating a date and time when the multi-media file is imported.

The “content information” 52 may include “content type” 52a, “profile” 52b, “resolution” 52c, “length” 52d, “bit rate” 52e, “title name” 52f, “artist name” 52g, “album name” 52h, “genre” 52i and “creation date” 52j. The “content type” 52a is information indicating any one of the moving image, the still image, and the music, and the “profile” 52b is information indicating file format information (such as MP3, WMA, and WMV). The “resolution” 52c is quality information of the moving image or the still image, the “length” 52d is time information of the moving image or the music, and the “bit rate” 52e is quality information of the moving image or the music. The “title name” 52f, the “artist name” 52g, the “album name” 52h, the “genre” 52i, and the “creation date” 52j are so-called tag information of the multi-media file.

The “reproduction information” 53 may include “reproduction count” 53a and “reproduction starting position” 53b. The “reproduction count” 53a indicates the number of reproductions of the content by the user, and the “reproduction starting position” 53b is reproduction position information at a temporal axis when reproduction is interrupted in the middle of the last reproduction. That is, it is reproduction-resume-time position information used for resuming, and is mainly used for the moving image.

The “additional information” may include a “favorite ranking” 54a. The “favorite ranking” 54a indicates user's content evaluation on a scale of 1 to 5, for example, and is an item that can be arbitrarily set by the user.

The information is to be managed for each multi-media file, recorded in the database 44, and updated where appropriate.

The multi-media files are each accommodated in the predetermined accommodated location 51b, and are managed in units of folders. The folder name can be set freely by the user, and the icon image of the folder can also be set. A fixed phrase of the folder name or a template of the icon image is registered in the database 44, and the user can select a desired phrase or template from the database 44 and set the selected phrase or template.

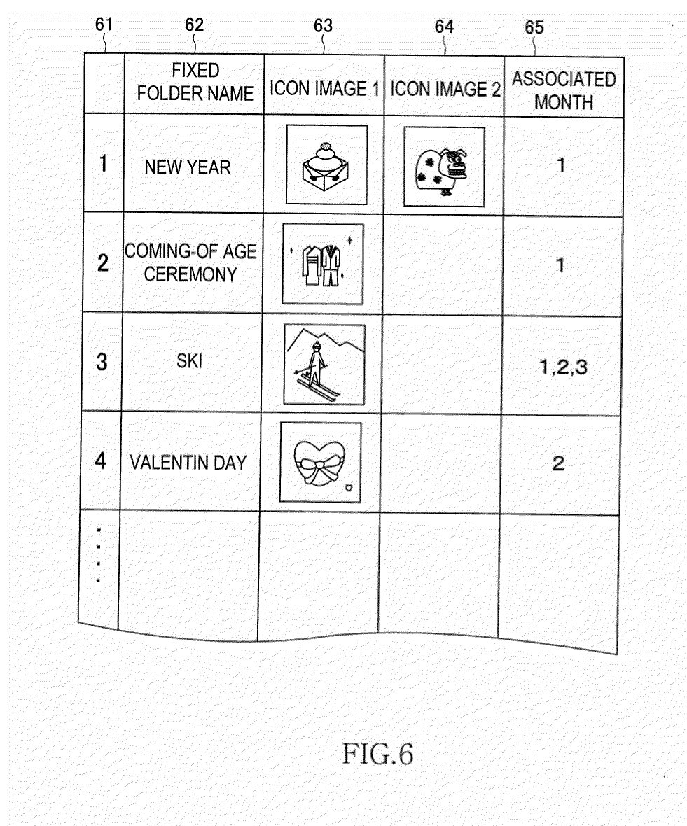

FIG. 6 is a table showing one example of a database for managing the fixed folder names and the icon images in the first embodiment.

As shown in FIG. 6, “ID” 61, “fixed folder name” 62, “icon image 1” 63, “icon image 2” 64 and “associated month” 65 and the like are registered in the database. The ID 61 is a code for uniquely identifying the fixed folder name 62. The fixed folder name 62, the icon images 63 and 64, and the associated month 65 are associated with the ID 61. While the ID 61 and the fixed folder name 62 are in a one-to-one relation, the ID 61 and the icon images are in a one-to-many relation. There are cases that a plurality of the icon images 63 and 64 are associated with the single ID 61. For example, in FIG. 6, two icon images are registered for a fixed folder name “New Year”. The fixed folder name 62 is associated with each month (season) of January to December. For example, the fixed folder name of “New Year” or “Coming-of-Age ceremony” is associated with January, “Valentine's Day” is associated with February, and “ski” is associated with January to March. The fixed folder names related with the season can be selected from the “monthly folder list”.

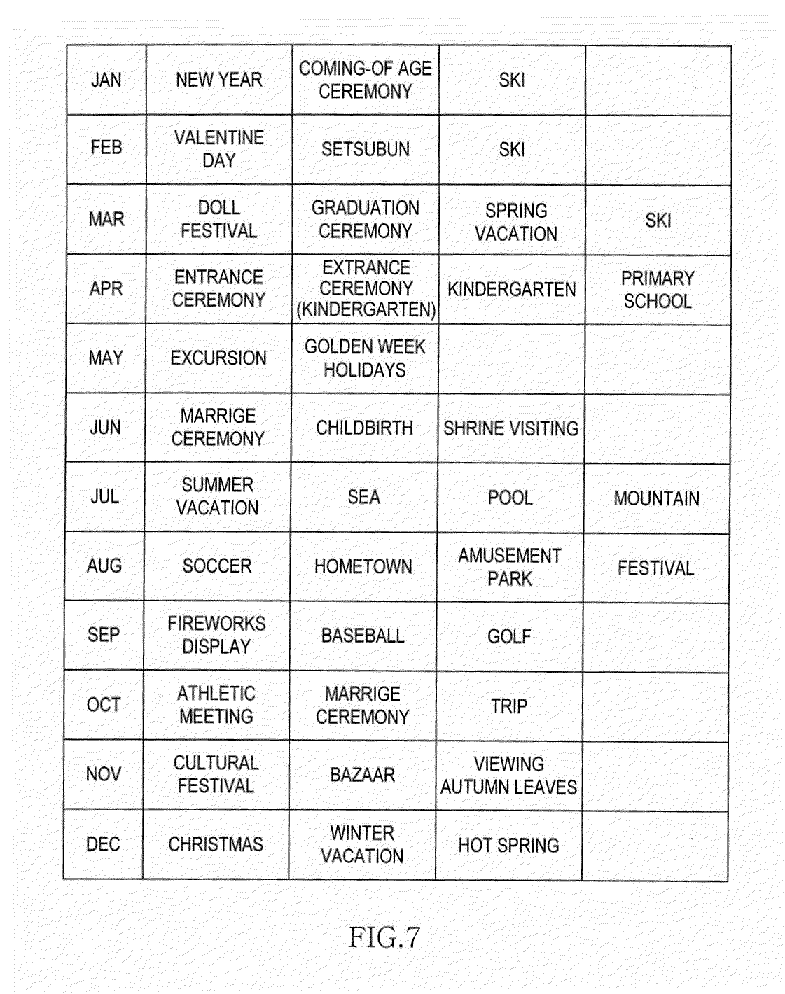

FIG. 7 is one example of the monthly folder list in the first embodiment.

As shown in FIG. 7, in the monthly folder list, the fixed folder names associated with each month from January to December are registered. For example, folder names such as “New Year”, “Coming-of-Age ceremony”, and “ski” are registered for January, and folder names such as “Valentine's Day”, “Setsubun (the day before the calendric beginning of spring)”, and “ski” are registered for February. “Ski” is associated with all of January to March, and thus it is registered for January, February, and March.

Some fixed folder names do not belong to the monthly folder list. For example, keywords such as “Hoji (Buddhist sermon)”, “grandchild”, “son”, “daughter”, and “party” are not related with the season, and thus these are not registered in the monthly folder list. The fixed folder names not related with the season can be selected not from the monthly folder list but from the “all folder list”.

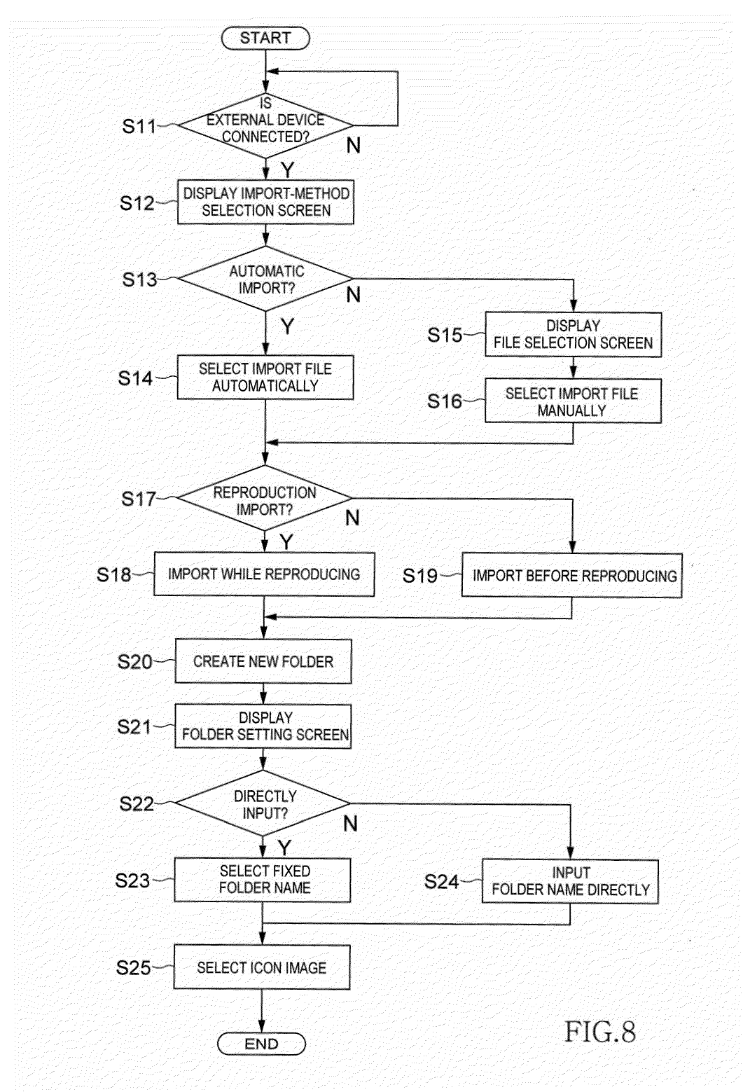

With reference to the flowchart in FIG. 8, an operation of the multi-media server 11 is described next in detail.

When the external device such as a video camera is first connected to the multi-media server 11 (YES at step S11), the multi-media server 11 is activated, and an “importing-method selection screen” is displayed on the display 12 (step S12)

The user can select either “automatic import” or “manual import” on “importing-method selection screen”. When the “automatic import” is selected (YES at step S13), the file importing unit 41 compares the files within the external device with those accumulated within the multi-media server 11, and a multi-media file that has not yet been imported is automatically selected (step S14). On the other hand, when the “manual import” is selected (NO at step S13), the file importing unit 41 displays a list of multi-media files within the external device (step S15), and thus the user can freely select a file that is desired to be imported (step S16).

When an import-target file is thus selected, a reproduction-import selection screen is subsequently displayed. On an import-mode selection screen, the user can select either a “reproduction import mode” in which an import process is performed while the content is reproduced or a “normal import mode” in which only the import process is performed while the content is not reproduced (steps S17 to S19). Import of the multi-media file is then started. In the reproduction import mode, the import process is performed while the multi-media file is reproduced (step S18). In the normal import mode, the file is not reproduced and the import process only is performed (step S19), and a progress bar indicating an import progress status is displayed on the display.

Upon completion of the import of the multi-media file, a new folder is then created (step S20), and a “folder setting screen” for setting the folder is displayed (step S21). The user can select the “folder name” and the “icon image” on the folder setting screen (steps S22 to S25).

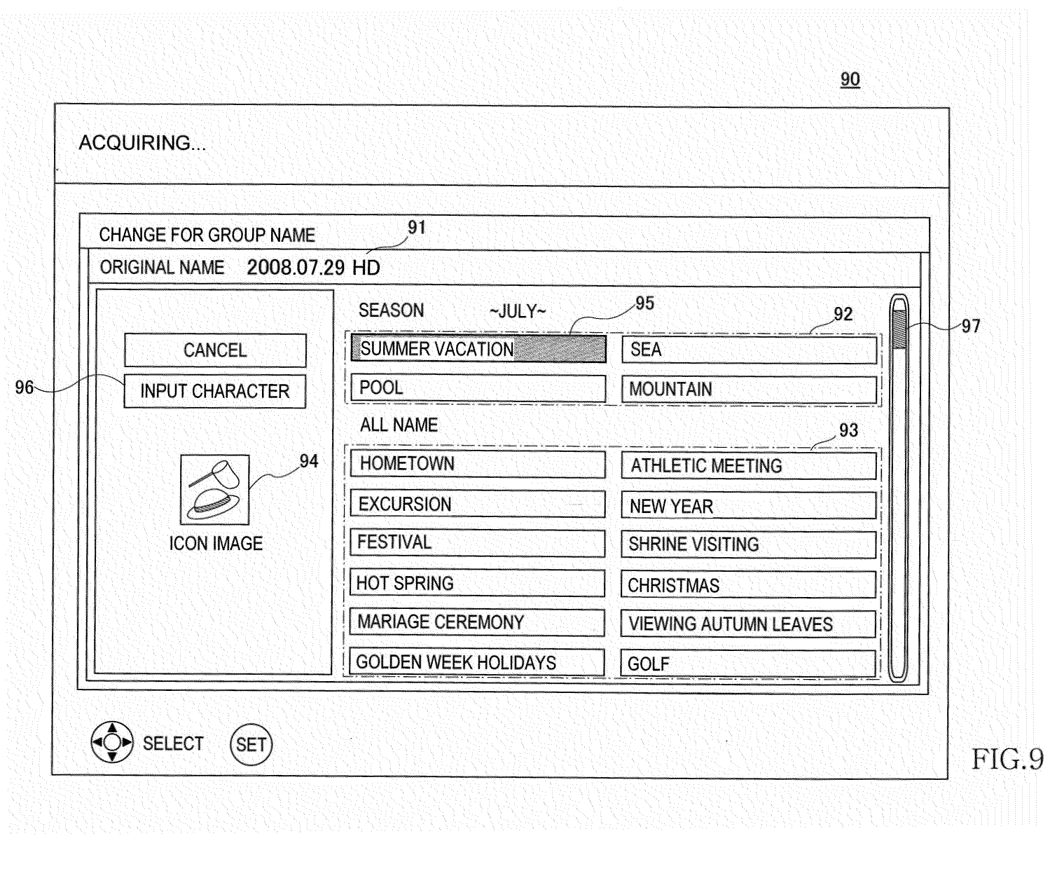

FIG. 9 is a schematic diagram showing one example of the folder setting screen in the first embodiment.

As shown in FIG. 9, the folder setting screen shows “original name” 91, “monthly folder list” 92, “all folder list” 93 and “icon image” 94. The “original name” 91 is a default folder name. For the default folder name, all or one portion of the file name of the multi-media file is adopted, and when there are plural multi-media files, a head file name is adopted. Usually, at the time point when the external device creates the multi-media file (at the time of photographing), a predetermined code including the creation date is often used as the file name. Such a code is set as it is as the default folder name. It is understood that the creation date of the import file is Jul. 29, 2008 in FIG. 9.

When the user desires to change the folder name to a name more intuitive and easier to understand, the user can select a folder name from the “monthly folder list” 92 or the “all folder list” 93 (step S23), or click a “character input” button 96 to call a software keyboard so that the folder name can be directly inputted through the software keyboard (step S24). Changing of the folder name is described in detail below.

The folder name can be selected from the “monthly folder list” 92. The monthly folder list 92 is provided based on the database shown in FIG. 7. On the monthly folder list 92, the fixed folder names associated with the “month” of the creation date of the import file are displayed. In FIG. 9, the creation date of the import file is “2008.07.29”, and thus events and matters associated with July, i.e., “summer vacation”, “sea”, “swimming pool”, and “mountain”, are displayed. The user can select a fixed folder name therefrom. In FIG. 9, a cursor 95 is set on the “summer vacation”. However, when the user operates the remote controller 26 to move the cursor 95, an arbitrary fixed folder name can be selected.

The folder name can be also selected from the “all folder list” 93. The all folder list 93 is provided based on the database shown in FIG. 6. On the all folder list 93, irrespective of the creation date of the import file, all the fixed folder names registered in the database are displayed in the order of the Japanese syllabary, for example. In FIG. 9, events (such as “athletic festival” and “New Year”) belonging to the season other than July, and events (such as “countryside” and “hot spring”) not related with the season are displayed. The user can select a fixed folder name therefrom. It may be difficult to contain the monthly folder list 92 and the all folder list 93 on one screen. Thus, a scroll bar 97 is prepared, and when the scroll bar 97 is moved, an appropriate list is displayed.

On the folder setting screen 90, the icon image 94 of the currently selected fixed folder name is displayed. The icon image 94 is provided from database shown in FIG. 6. In FIG. 9, “summer vacation” is selected, and thus an icon image that recalls the summer vacation (a straw hat and a butterfly net) is displayed. In this case, when the remote controller is operated to change the fixed folder name, the icon image is changed together therewith.

As described above, the relation between the fixed folder name and the icon image is not necessarily one to one, and there are cases that a plurality of icon images are associated with one fixed folder name. In these cases, when the icon image is clicked, the icon image is sequentially changed, and then, another icon image can be selected.

The folder name can also be inputted through a software keyboard by the user himself or herself, instead of being selected from the “monthly folder list” 92 or the “all folder list” 93. For example, when the “character input” button 96 is clicked in a state that the “summer vacation” is selected as the fixed folder name and the icon image thereof is displayed, the software keyboard is displayed. When the user inputs an arbitrary folder name, the inputted folder name becomes a folder name of a destination folder of the import file, and the same icon image (a straw hat and a butterfly net) as that of “summer vacation” is set (step S25).

Thus, upon completion of setting the “folder name” and the “icon image”, a plurality of multi-media files are grouped. The destination folder of the imported file is associated with the “folder name” and the “icon image”, and thus, when the user desires to reproduce this multi-media file later, the user can use the information as a key to promptly find the intended file.

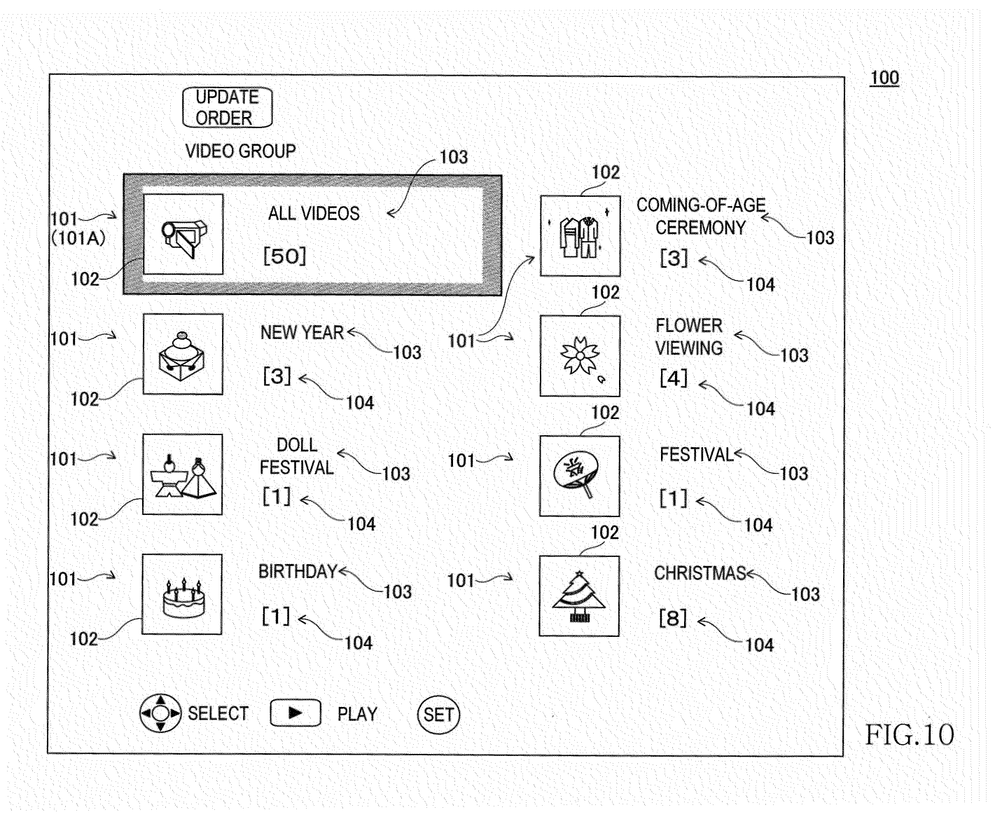

FIG. 10 is a schematic diagram showing one example of a screen layout of a reproduction list displayed at the time of reproduction in the first embodiment.

As shown in FIG. 10, on a reproduction list 100, multi-media files targeted for reproduction are displayed in units of folders. A folder name 103 and an icon image 102 of each folder 101 are set at the time of import. Specifically, folder names such as “New Year”, “Doll Festival”, and “birthday” are set. The reproduction list 100 shown in FIG. 10 is for a video group, and reproduction lists for a picture group or a music group are also prepared.

For the reproduction list 100, a folder 101A named as “all videos” is also prepared, and all the multi-media files can be selected by clicking the icon image 102 of the “all videos” folder 101A. In FIG. 10, a cursor is set on the “all videos” folder 101. However, when the remote controller 26 is operated to move the cursor, an arbitrary folder can be selected. Numbers in bracket denoted by “104” for the respective folders 101 indicate the number of the multi-media files saved in the corresponding folders. The user can intuitively comprehend the contents from the folder name 103 and the icon image 102, and thus the user can promptly find the file to be reproduced.

As described above, according to the first embodiment, when importing the multi-media files from the external device, the folder name and the icon image of the destination folder of the multi-media file can be selectively set from a list of the fixed folder names classified into months. Thus, it becomes easy to manage the digital contents, and the multi-media file to be reproduced can be easily found.

According to the first embodiment, the all folder list, together with the monthly folder list, is displayed, and the fixed folder name and the icon image can be selected also from the all folder list. Thus, even when there is no appropriate fixed folder name in the monthly folder list, the fixed folder name and the icon image can be easily selected with a straightforward operation.

According to the first embodiment, in addition to the selection input using the monthly folder list and the all folder list, the direct input through the software keyboard is enabled. Thus, the folder name suitable for the content of the import file can be freely set.

Characteristics of the multi-media server 11 relating to a method of displaying a list of the multi-media files in the external device are described next as the second embodiment.

### Second Embodiment

A basic configuration of a multi-media server system according to the second embodiment is the same as that shown in FIG. 1. The exterior structure of the multi-media server 11 is also the same as that shown in FIGS. 2A and 2B. The internal configuration is also the same as that shown in FIG. 3. That is, the system configuration of the multi-media server, the exterior structure thereof, and the internal structure thereof in the second embodiment are basically the same as those described as the first embodiment.

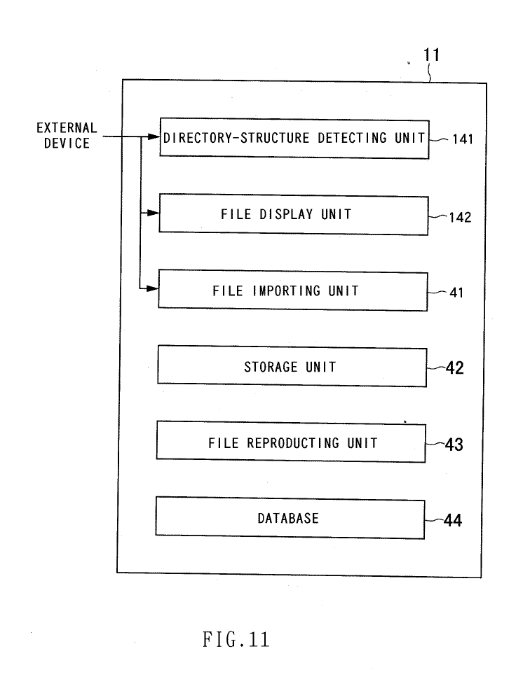

FIG. 11 is a functional block diagram of the multi-media server 11 according to the second embodiment.

Some functional blocks of the multi-media server system according to the second embodiment are common to those in FIG. 4. The components designated by like reference numerals as those in FIG. 4 have the same or similar functions as those described in FIG. 4. As components to be added to FIG. 4, the multi-media server 11 according to the second embodiment includes a directory-structure detecting unit 141 that detects a specific directory structure within the external device, and a file display unit 142 that directly displays a list of the multi-media files included in a predetermined folder of a specific directory structure when the specific directory structure is detected. Similarly to the first embodiment, the multi-media server 11 according to the second embodiment can also include the folder setting unit 45, the reproduction-list display unit 46, and character input unit 47. Detection of the directory structure by the directory-structure detecting unit 141 is started when connection with the external device is recognized. However, the detection can be started in other cases.

Also in the second embodiment, the information of multi-media files managed by the database 44 is the same as that in FIG. 5. That is, the information of the multi-media files in the second embodiment is fundamentally equivalent to that described in the first embodiment.

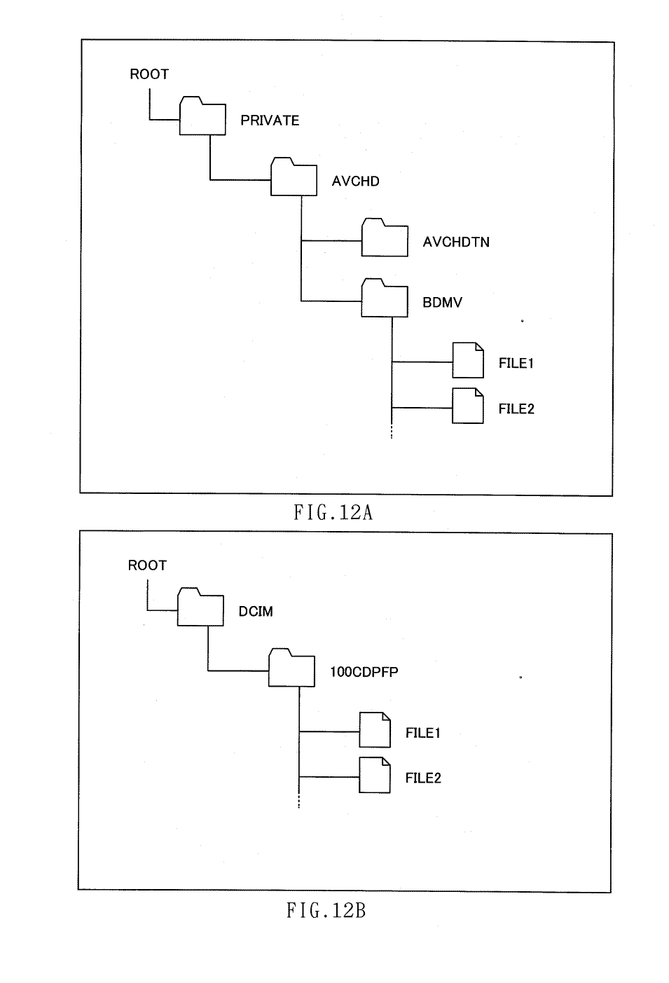

FIGS. 12A and 12B are tables each showing one example of the directory structure of the external device.

As shown in FIG. 12A, in an external device, such as a Handycam® which complies with an AVCHD standard, a folder named “PRIVATE” is provided in a root directory, and under that, an “AVCHD” folder is provided, and yet under that, an “AVCHDTN” folder and a “BDMV” folder are provided. Moving image files (FILES 1, 2, . . . ) are saved within the “BDMV” folder.

As shown in FIG. 12B, in an external device, such as a digital camera, which is standardized with JEIDA, a folder named “DCIM” is provided in a root directory, and under the “DCIM” folder, a folder named “100CDPFP” (the portion of “CDPFP” differs depending on each external device), for example, is provided. Still image files (FILES 1, 2, . . . ) are saved within the “100CDPFP” folder.

In this way, there is a prescribed rule in the directory structure of the external device, and the rule differs depending on types of external devices. Accordingly, in the second embodiment, a specific directory structure of the external device is detected, and a list of multi-media files within a predetermined folder in the specific directory structure is directly displayed. That is, in a case of the external device that complies with the AVCHD standard, a list of moving image files within the “BDMV” folder is displayed, and in a case of the external device that complies with the JEIDA standard, a list of still image files within the “100CDPFP” folder is displayed.

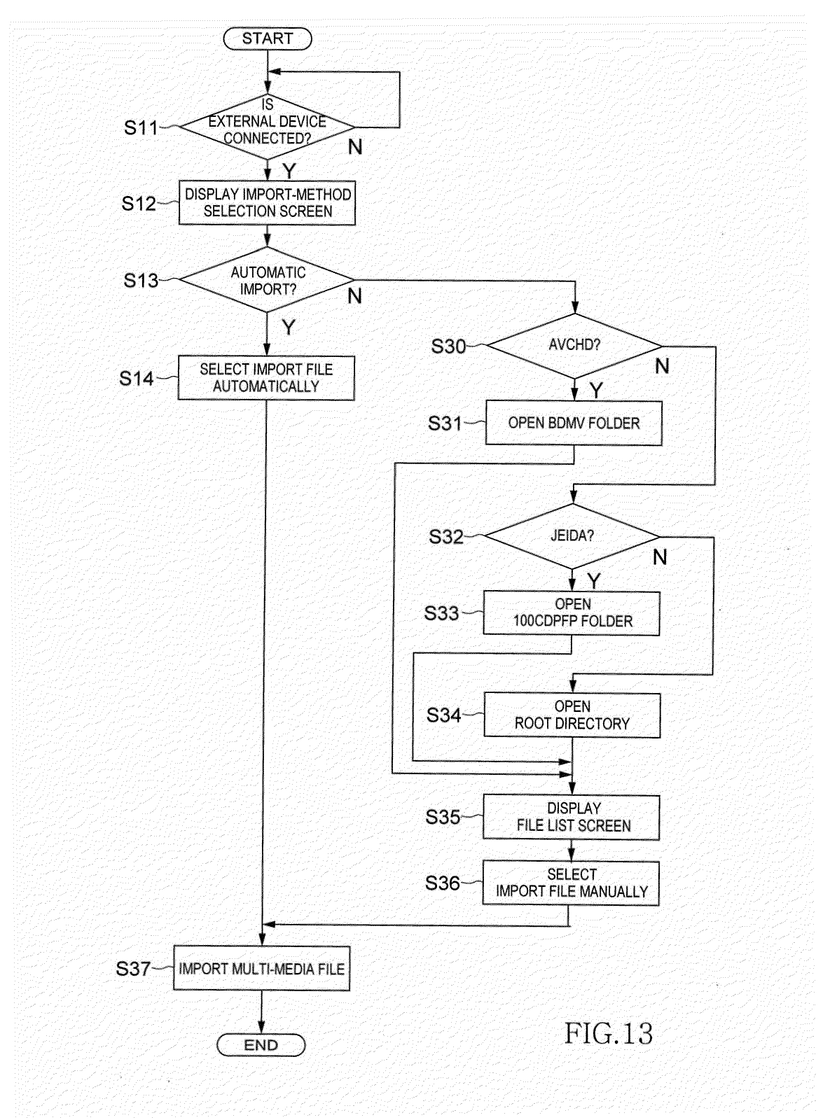

With reference to the flowchart in FIG. 13, an operation of the multi-media server 11 according to the second embodiment is described next in detail.

In this case, processes from steps S11 to S13 are the same as those in the steps designated with the same numbers in FIG. 8. When the user selects “automatic import” (YES at step 13), files in the external device and files accumulated in multi-media server 11 are mutually compared, the file which has not been imported to the server from the external device is automatically selected (step 14). On the other hand, when the user selects “manual import” (NO at step 13), the list of multi-media files within the external device is displayed and the user can freely select file to import.

At this time, the multi-media server 11 does not display the directory structures within the external device in order, but directly displays the list of multi-media files within a predetermined folder. Specifically, whether a directory structure complies with the AVCHD standard is determined (step S30), and when the determination result is YES, the list of moving image files within the “BDMV” folder is directly displayed (YES at step S30 and step S31). Subsequently, whether the external device complies with the JEIDA standard is determined (NO at step S30 and step S32), and when the determination result is YES, the list of still image files within the “100CDPFP” folder is displayed (YES at step S32 and step S33). When the external device does not comply with either of the standards, the folders and the files within the root directory are displayed (NO at step S32 and step S34)

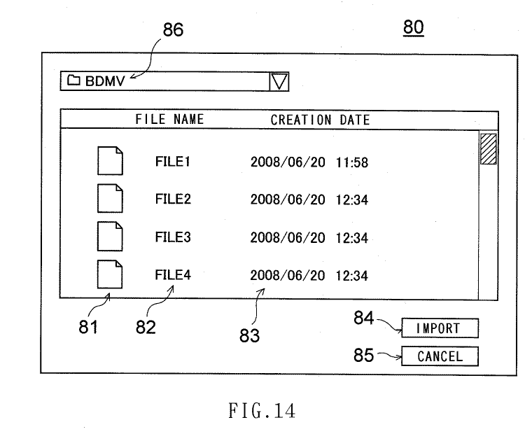

FIG. 14 is a schematic diagram showing one example of the file list screen.

As shown in FIG. 14, on a file list screen 80, a file icon image 81, a file name 82, a file creation date 83 and the like are displayed. When the user selects one or a plurality of files therefrom and clicks an “import” button 84, import is started. When a “cancel” button 85 is clicked, the import is canceled. On a directory display unit 86, a name of a folder currently opened is displayed. In this case, it is understood that a “BDV” folder is opened.

When an import-targeted file is selected from the file list screen 80 thus displayed (steps S35 and S36), file is imported (step S37), and the multi-media files within the external device are accumulated in the storage unit 42 within the multi-media server 11. Note that during import, the import can be performed while the content is reproduced, or the import only can be performed without reproducing the content.

It can be said that the processes from steps S30 to S35 in FIG. 13 are associated with step S15 in FIG. 8.

As described above, according to the second embodiment, the directory structures are not displayed in order but the list of multi-media files within a predetermined folder is directly displayed. Therefore, the user does not need to be conscious of which layer in the directory structure contains the multi-media file, and thus a highly convenient system can be realized.

The present invention has been explained based on the preferred embodiments. However, the present invention is of course not limited to the embodiments above described and can be variously modified without departing from the spirit or scope of the present invention.

For example, in the first embodiment, the example in which both the folder name and the icon image are changed is described. However, the icon image only can be changed. In FIG. 10, the folder name, the icon image, and the number of files are displayed for each folder. The creation date of the folder can also be displayed.

In the first embodiment, the fixed folder name is associated with the “month” in the monthly folder list. However, the fixed folder name can be associated with the year, the day of the week, the day, the time, or the like, in addition to the “month”.

In the first and second embodiments, the USB is used as an example of the external interface for connecting to the external device such as a digital camera. However, in the present invention, the external interface is not limited to the USB and various interfaces can be utilized.

In the first and second embodiments, as shown in FIG. 3, the hard disk drive 35is used as the storage unit. However, a semiconductor memory such as a flash memory can be also used. In addition, an optical disk device such as a DVD and a Blu-ray® disk can be also used. These storage units can be used also in combination.

For example, in the second embodiment, as types of a specific directory structure within the external device, two standards, i.e., the AVCHD standard and the JEIDA standard, are used. However, the present invention is not limited thereto, and is able to be compatible to various types of directory structures and to detect all of these directory structures.

What is claimed is:

1. A multi-media server capable of connecting to a digital television, comprising:
a file importing unit that imports a multi-media file from an external device;
a storage unit that stores therein the imported multi-media file;
a file reproducing unit that reproduces the multi-media file stored in the storage unit;
a database that manages the multi-media file stored in the storage unit for each folder; and
a folder setting unit that acquires creation-date data of the imported multi-media file, displays a list of fixed folder names associated at least with a month of the creation date, and sets one fixed folder name selected from the list as a destination folder name of the imported multi-media file.

2. The multi-media server as claimed in claim 1, wherein the folder setting unit sets, in addition to the fixed folder name, an icon image associated with the fixed folder name as an icon image of the destination folder of the imported multi-media file.

3. The multi-media server as claimed in claim 1, wherein the folder setting unit displays, in addition to the fixed folder name, a plurality of icon images associated with the fixed folder name, and sets one icon image selected from among the icon images as an icon image of the destination folder of the imported multi-media file.

4. The multi-media server as claimed in claim 1, further comprising a reproduction-list display unit that displays a reproduction list including the folder name and the icon image of the folder registered in the database, wherein
the file reproducing unit reproduces the multi-media file saved in the folder selected from the reproduction list displayed by the reproduction-list display unit.

5. The multi-media server as claimed in claim 1, wherein the folder setting unit further displays a list of all registered fixed folder names, in addition to the list of the fixed folder names associated at least with the month of the creation date.

6. The multi-media server as claimed in claim 1, wherein the file importing unit includes an automatic importing unit that automatically imports multi-media files from the external device, and a manual importing unit that imports a multi-media file selected by a user from among the multi-media files from the external device.

7. The multi-media server as claimed in claim 1, further comprising a character input unit, wherein
the folder setting unit sets a character string directly inputted via the character input unit as the destination folder name of the multi-media file.

8. The multi-media server as claimed in claim 1, further comprising:
a directory-structure detecting unit that detects a specific directory structure within the external device; and
a file display unit that displays a list of multi-media files within a predetermined folder of the specific directory structure when the directory structure is detected, to enable a user to select an import-target multi-media file.

9. The multi-media server as claimed in claim 8, wherein the directory-structure detecting unit detects the specific directory structure when connection of the external device is recognized.

10. A multi-media server capable of connecting to a digital television, comprising:
a directory-structure detecting unit that detects a specific directory structure within an external device; and
a file display unit that displays a list of multi-media files within a predetermined folder of the specific directory structure when the directory structure is detected.

11. The multi-media server as claimed in claim 10, wherein the directory-structure detecting unit detects the specific directory structure when connection of the external device is recognized.

12. The multi-media server as claimed in claim 10, further comprising:
a file importing unit that imports at least one multi-media file selected on the file display unit;
a storage unit that stores therein the imported multi-media file; and
a file reproducing unit that reproduces the multi-media file stored in the storage unit.
